(19) United States
(12) Patent Application Publication
(10) Pub. No.: US 2026/0339122 A1
(43) Pub. Date: Oct. 29, 2026

(54) OPTICAL LENS ASSEMBLY FOR USER TO ACHIEVE PERIPHERAL MYOPIC DEFOCUS AND GLASSES

(71) Applicant: Beijing NED+ AR Display Technology Co., Ltd., Beijing (CN)

(72) Inventors: Qiwei WANG, Beijing (CN); Da WANG, Beijing (CN); Dewen CHENG, Beijing (CN)

(73) Assignee: Beijing NED+ AR Display Technology Co., Ltd., Beijing (CN)

(21) Appl. No.: 19/698,760

(22) Filed: Jun. 4, 2026

Related U.S. Application Data
(63) Continuation of application No. PCT/CN2024/137056, filed on Dec. 5, 2024.

(30) Foreign Application Priority Data
Dec. 19, 2023 (CN) 202311755353.8

(51) Int. Cl. G02C 7/02; G02B 27/01; G02B 27/12; G02B 27/28; G02C 11/00

(52) U.S. Cl. CPC G02C 7/022; G02B 27/0172; G02B 27/126; G02B 27/283; G02C 11/10; G02B 2027/0178; G02C 2202/16; G02C 2202/24

(57) ABSTRACT

This invention relates to an optical lens assembly and glasses for users to achieve peripheral myopic defocus, which can present a positively defocused image in the user's peripheral field of vision while the user observes a real scene, and simultaneously achieving myopia control and refractive correction. The optical lens assembly consists of a first lens, a second lens, and a projector; the first lens has a plurality of radially distributed defocus units; the image light of the predetermined image enters a defocus unit after passing through the projector, propagates via total internal reflection and is reflected at the beam splitting exit surface located near the center of the first lens, and then exits as converging light, which can enter the human eye at the exit pupil and form a defocused image in the peripheral field of vision in front of the retina.

### CROSS-REFERENCE TO RELATED APPLICATIONS

This application is a continuation of International Patent Application No. PCT/CN2024/137056 filed on Dec. 5, 2024, which claims priority to Chinese Patent Application No. 202311755353.8 filed on Dec. 19, 2023. The disclosures of the above-referenced applications are hereby incorporated by reference in their entirety.

### TECHNICAL FIELD

This invention relates to an optical lens assembly for users to achieve peripheral myopic defocus and glasses using the same, particularly to an augmented reality optical lens assembly with a thin and light appearance, achieving an appearance extremely similar to ordinary refractive corrective lenses, allowing it to be worn indistinguishably from ordinary glasses. The virtual image of the peripheral myopic defocus optical system is focused in front of the retina after passing through the human eye, thereby achieving the effect of preventing irreversible changes in refractive power and realizing the purpose of myopia prevention.

### BACKGROUND

Influenced by factors such as the younger age of electronic device usage, myopia shows a high incidence and a trend toward younger age. Medically, myopia is considered to be the result of excessive eye growth. When the retina receives negative optical defocus, the retinal image is always behind the retina, which accelerates eye growth and induces myopia (hyperopic defocus, elongation of the axial length). Conversely, when the retina receives positive optical defocus, the retinal image is always in front of the retina, which inhibits eye growth and leads to hyperopia (myopic defocus, shortening of the axial length).

Studies have shown that both the central and peripheral regions of the retina are involved in the eye growth process, but the role of the central region is relatively limited. Moreover, as the main light path usually located directly in front of the eyeball, its visual clarity should be prioritized, that is, to fulfill the biological function of the eye. Therefore, defocused lenses that utilize peripheral focus to inhibit further myopia progression have emerged. These lenses maintain a hollow or approximately non-refractive state in the central region, while incorporating specific optical structures in the peripheral region. It thereby achieves both clear focus of the image on the retina and the simultaneous generation of an additional defocused image in front of the retina, thus enhancing optical stimulation for near-distance vision. Thus, when users whose eyes are still developing use these lenses to view objects, an image of the object is formed on the central retina, while a positively defocused image is also formed at a point in front of the retina. This enables visual recognition of the object's image while simultaneously inhibiting myopia progression based on the image formed in front of the retina.

### SUMMARY

This invention provides an optical lens assembly for users to achieve peripheral myopic defocus, and glasses that achieve peripheral myopic defocus, enabling a peripheral defocus optical device in a thin and lightweight eyeglass form.

According to a first aspect of the present invention, an optical lens assembly for a user to achieve peripheral myopic defocus is provided, comprising:
a first lens having a plurality of defocus units, the first lens being generally circular and being positioned facing the human eye;
a second lens cooperating with the first lens, the second lens having an area roughly the same as that of the first lens and being positioned on the side of the first lens away from the human eye; and,
a projector for projecting a predetermined image into a defocus unit, the projector comprising at least one projection optical lens;
wherein, image light of a predetermined image enters a defocus unit via a projector, and is reflected at least four times within the first lens and propagates toward the center of the first lens, and then reflected by a beam splitting exit surface opposite the projector, exits the defocus unit and enters the human eye to form a defocused image;
the defocusing range of the beam splitting exit surface is opposite to the physical position of the beam splitting exit surface relative to the central axis of the first lens;
the plurality of defocus units are radially distributed in the first lens.

Preferably, the defocus unit comprises: a coupling incident surface disposed on the outer peripheral edge of the first lens, a beam splitting exit surface disposed near the center of the first lens, and two reflective transmission surfaces constituting the outer surface of the first lens, wherein the beam splitting exit surface and the two reflective transmission surfaces are concave surfaces with respect to the human eye position in the exit direction, and the two reflective transmission surfaces are configured to refract light incident through the coupling incident surface toward the beam splitting exit surface by total internal reflection.

Preferably, an eye-side surface of the first lens is a rotationally symmetric spherical or aspherical surface, and is in a continuous state.

Preferably, a surface of the first lens located on the outer side of the eye can be a continuous single curved surface or a combination of multiple non-continuous curved surfaces, and light is transmitted between the two surfaces by total internal reflection, or by beam splitting or polarization beam splitting.

Preferably, the beam splitting exit surface is a freeform surface.

Preferably, the radially distribution of defocus units are configured to ensure that exit pupils of the defocus units are the same or located within the same region.

Preferably, the multiple defocus units are distributed at equal angles, and a number of the multiple defocus units is an odd number greater than or equal to 3 and not exceeding 9. Alternatively, the multiple peripheral defocus units are distributed at non-equal angles, and the number of the multiple defocus units is greater than or equal to 3.

Preferably, any defocus unit does not form an angle of 180° with other defocus units.

Preferably, the defocus unit has an intermediate image plane within the first lens.

Preferably, the projection optical lens of the projector is selected from one or more combinations of: a wedge-shaped curved prism, an aspherical lens, and a reflecting mirror.

Preferably, an angle by which the defocusing range of the beam splitting exit surface deviates from the central field is between 15° and 30°.

According to a second aspect of the present invention, eyeglasses for achieving peripheral myopic defocus are provided, comprising: rearwardly extending temples, a frame disposed at the front end of the temples, and at least one optical lens assembly fixed within the frame, wherein, the predetermined image is formed by illuminating a mask image plate with an LED illumination source, or is emitted by a micro-display image source selected from LCOS, DLP, OLED, and Micro LED, and the temples are configured such that the distance between the surface of the first lens on the side facing the human eye and the anterior surface of the eye is in the range of 14 mm to 16 mm

Preferably, the position of the micro-display image source is adjustable so that the diopter of the defocused image can be adjusted between +1 D and +5 D.

The optical lens assembly provided by the present invention focuses the light emitted by a micro-image source in front of the retina after it passes through a defocus unit in the first lens, thereby achieving the effect of preventing and controlling irreversible changes in diopter and realizing the purpose of myopia prevention and control. According to the glasses provided by the present invention for achieving peripheral myopic defocus, both the first lens and the second lens can be processed by high-precision injection molding using resin materials, with an overall thickness of less than 5 mm, making them thin and light, which is conducive to achieving an appearance similar to that of ordinary eyeglasses for vision correction.

### BRIEF DESCRIPTION OF THE DRAWINGS

FIG. 1 is a schematic cross-sectional view of the lens assembly according to the first embodiment of the present invention along the central ray of a defocus unit;

FIG. 2 is a schematic diagram of the peripheral defocus optical path according to the first embodiment of the present invention;

FIG. 3 is a schematic diagram of the transmission direction optical path according to the first embodiment of the present invention;

FIG. 4 is a schematic diagram of multiple defocus units distributed at equal angles in the first lens according to the first embodiment of the present invention;

FIG. 5 is a schematic diagram of the structure of the first lens and the second lens according to the first embodiment of the present invention;

FIG. 6 is a schematic diagram of multiple defocus units distributed non-equidistantly in the first lens according to the first embodiment of the present invention;

FIG. 7 is a schematic diagram of the defocus optical path of a modified example of the first embodiment of the present invention;

FIG. 8 is a schematic diagram of the defocus optical path of yet another modified example of the first embodiment of the present invention;

FIG. 9 is a schematic cross-sectional view of the lens assembly according to the second embodiment of the present invention along the central ray of a defocus unit;

FIG. 10 is a schematic diagram of the peripheral defocus optical path according to the second embodiment of the present invention;

FIG. 11 is a schematic diagram of the transmission direction optical path according to the second embodiment of the present invention;

FIG. 12 is a schematic diagram of the structure of the first lens and the second lens according to the second embodiment of the present invention;

FIG. 13 is a schematic cross-sectional view of the lens assembly according to the third embodiment of the present invention along the central ray of a defocus unit;

FIG. 14 is a schematic diagram of the peripheral defocus optical path according to the third embodiment of the present invention;

FIG. 15 is a schematic diagram of the structure of the first lens and the second lens according to the third embodiment of the present invention;

FIG. 16 is a schematic diagram of a peripheral defocus optical path according to a modified example of the third embodiment of the present invention;

FIG. 17 is a schematic diagram of a peripheral defocus optical path according to yet another modified example of the third embodiment of the present invention;

FIG. 18 is a schematic diagram of a peripheral defocus optical path according to yet another modified example of the third embodiment of the present invention;

FIG. 19 is a schematic diagram of a peripheral defocus optical path according to a fourth embodiment of the present invention;

FIG. 20 is a schematic diagram of a peripheral defocus optical path according to a modified example of the fourth embodiment of the present invention;

FIG. 21 is a schematic diagram of a peripheral defocus optical path according to a fifth embodiment of the present invention;

FIG. 22 is a structural schematic diagram of the first lens and the second lens according to the fifth embodiment of the present invention;

FIG. 23 is a schematic diagram of a peripheral defocus optical path according to a modified example of the fifth embodiment of the present invention;

FIG. 24 is a cross-sectional schematic diagram of a lens assembly along the central ray of a defocus unit according to a sixth embodiment of the present invention;

FIG. 25 is a schematic diagram of a peripheral defocus optical path according to the sixth embodiment of the present invention;

FIG. 26 is a structural schematic diagram of the first lens and the second lens according to the sixth embodiment of the present invention;

FIG. 27 is a schematic diagram of the peripheral defocus optical path according to the seventh embodiment of the present invention;

FIG. 28 is a schematic diagram of the structure of eyeglasses for achieving myopic defocus according to an embodiment of the present invention.

### DETAILED DESCRIPTION

Exemplary embodiments of the present invention will be described in detail below to explain the present invention, examples of which are illustrated in the accompanying drawings, wherein the same reference numerals always denote the same components. Unless explicitly stated otherwise, those skilled in the art should understand that the terms “first,” “second,” etc., are only understood to distinguish different components and do not contain any limiting effect on the order, and that the component structures also referred to as the first part may be different in different embodiments.

### First Embodiment

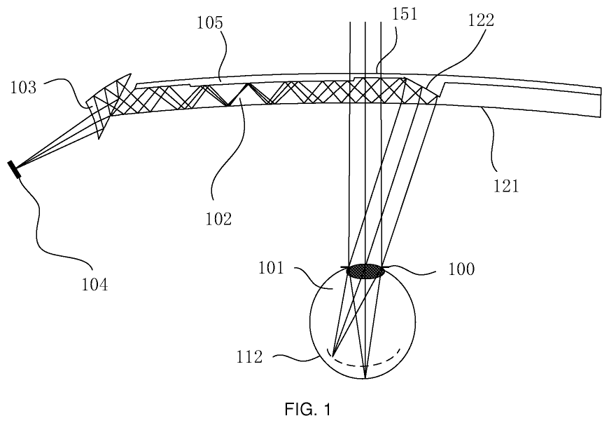

As shown in FIGS. 1 to 3, the optical lens assembly for achieving myopic defocus in peripheral vision according to the present invention comprises a first lens 102 located in front of the eye and having multiple defocus units. The first lens is generally circular or nearly circular in shape. On the outer side of the first lens 102 (i.e., the side not facing the eye), there is a second lens 105 that cooperates with the first lens. The defocus function of the defocus units is realized by parts of the first lens. The second lens 105 is used to compensate for the unevenness of the outer surface of the first lens caused by realizing the defocus function. The second lens and the first lens are combined to achieve transmission and vision correction functions similar to normal corrective glasses, as shown in FIG. 3.

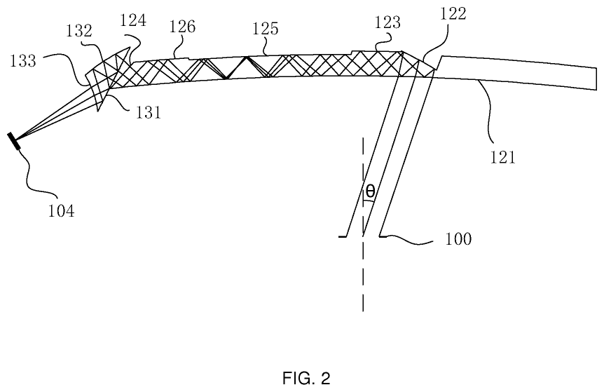

Specifically, as shown in FIG. 2, the defocus unit comprises: a coupling incident surface 124 disposed at the outer peripheral edge of the first lens, a beam splitting exit surface 122 disposed near the center of the first lens, and a reflection transmission surface (reflective surface for guiding/transmitting light, composed of multiple surfaces 123, 125, and 126) constituting the outer surface of the first lens away from the human eye, and a reflection transmission surface 121 constituting the outer surface of the first lens facing the human eye. The beam splitting exit surface 122 and the two reflection transmission surfaces are concave surfaces with respect to the human eye position in the exit direction. The two reflection transmission surfaces are configured such that the light incident through the coupling incident surface 124 is transmitted towards the beam splitting exit surface 122 by total internal reflection. The coupling incident surface 124 is inclined from the periphery towards the second lens and is preferably configured as a freeform surface to flexibly adjust the degree of bending of the incident light entering the first lens, thereby enabling the light transmitted through the coupling incident surface into the first lens satisfies the total internal reflection propagation condition. The beam splitting exit surface 122 is inclined approximately symmetrically with respect to the coupling incident surface 124 and is also preferably configured as a freeform surface, thereby enabling the light reaching the beam splitting exit surface no longer meets the total internal reflection condition and is reflected and emitted from inside the first lens 102 to the human eye 101 to form a myopic defocus image. The human eye 101 is located on the side away from the lens assembly at the exit pupil 100. Relative to the human eye position, the coupling incident surface 124 and the beam splitting exit surface 122 are located on the two curved surfaces on either side of that position, so that the total internal reflection transmission of light passes through the radial direction of the lens and crosses the center position. During the transmission, the light undergoes at least 8 total internal reflections within the first lens, and an intermediate image plane exists within the first lens during the light transmission process.

In the first embodiment, the reflection transmission surface 121 of the first lens facing the human eye is a rotationally symmetric sphere, or optionally an aspherical surface, and the reflection transmission surface 121 is a continuous surface; the surface opposite to the surface 121 of the first lens (i.e., the one on the outside relative to the eye) is preferably a discontinuous surface (see FIG. 2, spliced together by multiple surfaces 126, 125 and 123), having transmission segments corresponding to the corresponding parts of the surface 121. Light is transmitted to the beam-splitting exit surface 124 through multiple total internal reflections between the two reflection transmission surfaces. The distance between the two surfaces can vary, preferably with the variation being insignificant to satisfy the transmission in a total internal reflection manner. As another embodiment, the surface of the defocus unit away from the human eye can also be a complete surface, and the distance between the two surfaces is approximately uniform.

To better converge the light, the optical lens assembly of the present invention also comprises a projector for projecting a predetermined image onto a defocus unit. In the first embodiment, the projector is implemented as a wedge-shaped freeform prism 103. As shown in FIGS. 1 and 2, the image light of the predetermined image passes through surface 133 of the freeform prism 103 and is incident on surface 131. Total internal reflection occurs at surface 131, and the reflected light is then incident on surface 132 and undergoes total internal reflection again, guiding it to surface 131. Finally, it exits from surface 131 and is incident on the coupling incident surface 124, entering the first lens. Surface 131 is used to achieve the multiplexing of total internal reflection and transmission. When light first reaches surface 131, the total internal reflection condition is met, resulting in total internal reflection. When light reaches surface 131 the second time, the total internal reflection condition is not met, resulting in transmission. Alternatively, surface 131 can employ polarization technology to refract the light path. A polarizing beam-splitter and a quarter-wave plate are layered and attached to surface 131. In the light emitted from the micro-display image source, s-polarized light is reflected by the polarizing beam-splitter. The reflected light is converted into circularly polarized light by the quarter-wave plate. After reflection by surface 132, the circularly polarized light is converted into p-polarized light again by the quarter-wave plate. The p-polarized light then passes through the polarizing beam-splitter and enters the first lens. Total internal reflection at surface 132 can also be achieved by coating a total internal reflection film on surface 132.

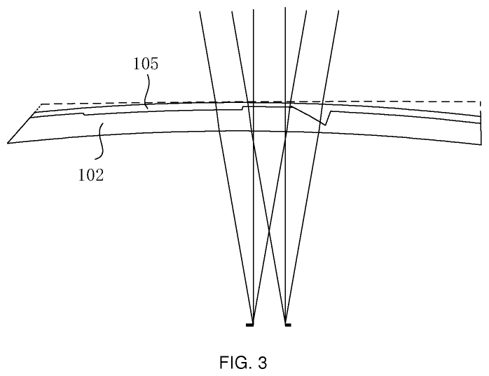

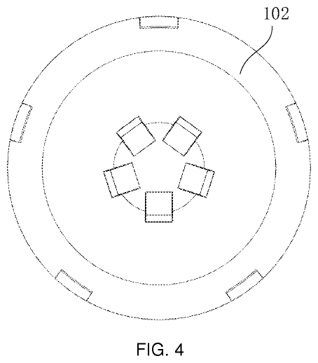

In order to obtain a balanced peripheral field defocusing effect, preferably, each defocus unit is formed in the first lens in a radially distributed manner, so that a single lens integrates multiple defocus units, forming multiple uniformly distributed defocused images. As shown in FIGS. 4 and 6, each defocus unit is distributed radially along the first lens. Multiple defocus units can be distributed circumferentially around the center of the first lens at equal or non-equal angles. Preferably, the multiple defocus units are distributed symmetrically with respect to the center of the lens (see FIG. 4) or with respect to a certain diameter (see FIG. 6). In the first embodiment, any defocus unit doesn't form an angle of 180° with other defocus units. Preferably, they are arranged in an odd number at equal intervals, meaning that when the first lens is roughly circular, there are no two completely opposite defocus units along the diameter of the circle. The number of defocus units distributed in the first lens is three or more. For the equiangular distribution of multiple defocus units, the number of defocus units is preferably an odd number, not less than three and not more than nine. For the non-equiangular distribution of multiple defocus units, the number of defocus units can be odd or even, preferably also meeting the range of 3 to 9.

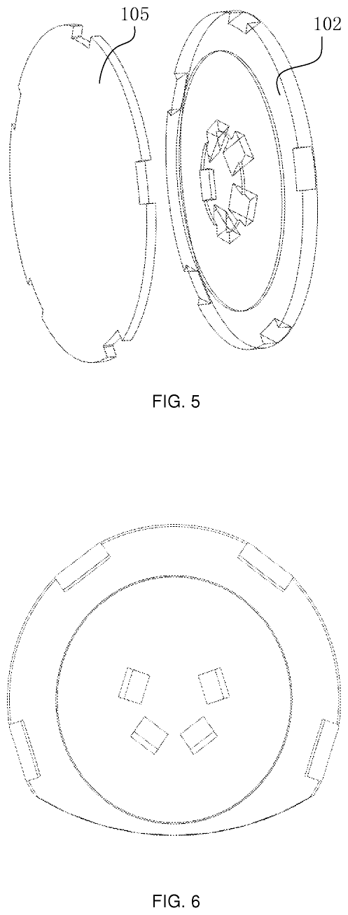

FIG. 5 shows the interaction between the first lens 102 and the second lens 105, and the first lens 102 have five defocus units. The defocus units form multiple uniformly distributed defocused images. The beam splitting exit surfaces of the defocus units are roughly arranged around the outer ring of the center of the lens. There is a certain gap between each beam splitting exit surface to completely separate the direction of the emitted light rays acting on each defocusing position. Considering the shaping of the beam splitting exit surfaces, it is necessary to maintain a gap. Preferably, the number of beam splitting exit surfaces around the outer ring of the center of the first lens does not exceed nine. The exit pupils of multiple defocus units are the same or slightly offset in the same area. This ensures that the human eye can receive the defocused images of multiple defocus units at the same time, while expanding the range of the exit pupil area.

To achieve visual stimulation sufficient to induce retinal imaging, the defocused image entering the human eye typically needs to have a certain brightness. Therefore, the predetermined image can be generated using a micro-display image source 104, such as a high-brightness LCOS, micro OLED, or micro LED. Alternatively, a specific image can be displayed as a micro-display image source by illuminating a mask with a predetermined pattern using LED illumination source. Those skilled in the art will understand that a mask with a predetermined pattern cannot support the display of dynamic images, and its image display flexibility is weaker than that of a micro-display, but it has advantages in cost and size, and facilitates control over the luminous brightness. Correspondingly, the beam splitting exit surface 122 has a beam splitting layer with a predetermined transmittance-reflection ratio, such as a commonly used semi-reflective film or other beam splitting films with different transmittance-reflection ratios, so that when image light reaches this exit surface, it can be reflected back to the interior of the first lens 102 as effectively as possible. The beam splitting ratio of the beam splitting film can be selected according to the luminous brightness of the micro-display image source 104 and balanced with the intensity of subsequent ambient light to obtain good image contrast.

Furthermore, by adjusting the position of the micro-display image source 104, the defocused image can be dynamically controlled to be adjusted between +1 D and +5 D to correspond to the diopter of the human eye, thereby achieving the purpose of matching the user and vision training.

FIG. 3 shows the schematic diagram of the ambient light transmission path. Light emitted from a normal external scene directly passes through the second lens 105 and the first lens 102 and enters the human eye. Preferably, a small air gap exists between the first lens and the second lens to ensure total internal reflection transmission of light within the first lens. The curvature change of the second lens's surface 151 on the side away from the human eye can be achieved by replacing the second lens or attaching an auxiliary lens, etc., to meet the usage requirements of the transmission optical path for people with different diopters.

The image light passing through the defocus unit enters the human eye 101 through the pupil (which acts as an aperture stop) and crystalline lens and is focused in front of the retina 112. Meanwhile, light emitted from the normal external scene directly passes through the second lens 105 and the first lens 102 into the human eye 101, and is able to focus on the retina 112. Thus, the human eye achieves the function of both viewing the external scene normally and forming a myopic defocus image in the peripheral field of vision, providing a certain effect on myopia prevention and treatment.

The optical surface parameters according to the first embodiment of the present invention can be shown in Table 1 below:

TABLE 1
Parameters of each optical surface in the lens assembly of the first embodiment

| Surface | Surface | | X | Y | Z | Alpha |
|---|---|---|---|---|---|---|
| mark | type | Radius | eccentricity | eccentricity | eccentricity | tilt |
| Aperture | Spherical | Infinity | 0 | 0 | 0 | 0 |
| (100) | | | | | | |
| 121 | Spherical | −197.60 | 0 | 0.000 | 15.00 | 0.00 |
| 122 | XY polynomial | −17.16 | 0 | −6.68 | 16.48 | −29.17 |
| 123 | Spherical | −64.61 | 0 | 0.00 | 17.30 | 0.00 |
| 125 | Spherical | −202.00 | 0 | 0.00 | 17.10 | 0.00 |
| 126 | Spherical | −202.00 | 0 | 0.00 | 17.30 | 0.00 |
| 124 | Spherical | Infinity | 0 | 20.55 | 15.14 | 48.95 |
| 131 | XY polynomial | −264.32 | 0 | 21.06 | 15.24 | 63.61 |
| 132 | XY polynomial | −13.85 | 0 | 22.02 | 16.55 | 33.92 |
| 133 | XY polynomial | 9.07 | 0 | 23.15 | 13.08 | 106.15 |
| 104 | Spherical | | 0 | 32.26 | 8.93 | 121.15 |

The freeform surface types in the beam splitting exit surface 122 and the freeform prism 103 are described in the form of XY polynomials, and the equation is as follows:

$$𝓏 = \frac{c ( {x}^{2} + {y}^{2} )}{1 + sqrt ( 1 - ( 1 + k ) {c}^{2} ( {x}^{2} + {y}^{2} ) )} + {\sum }_{{j = 2}^{}}^{66} {C}_{j} {x}^{m} {y}^{m} .$$

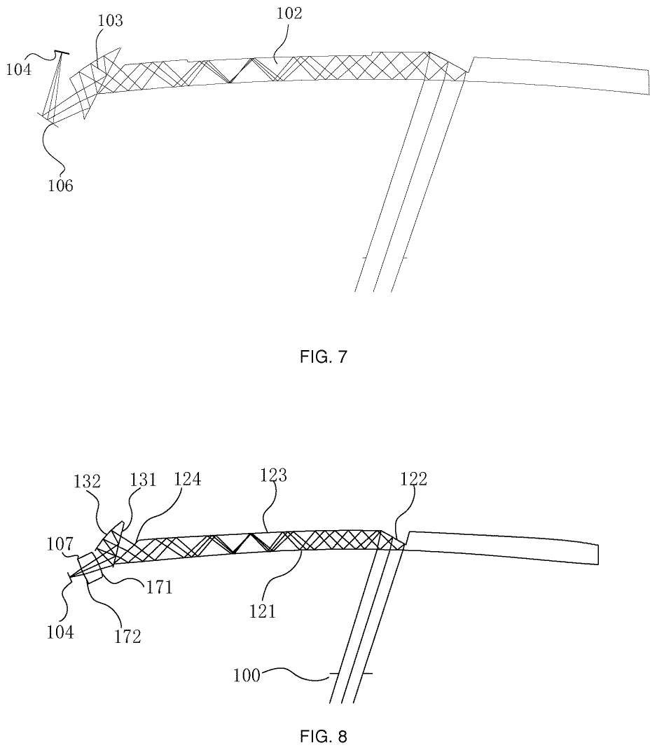

In order to further compress the overall size and volume of the system, as shown in FIG. 7, as a variation of the first embodiment, a plane mirror 106 can be added between the freeform prism 103 and the micro-display image source 104 to further fold the light path, so as to further compress the volume. At the same time, the plane mirror 106 can play a certain role in suppressing stray light.

As another implementation, as shown in FIG. 8, a peripheral field defocus optical path diagram of another variation of the first embodiment of the present invention is presented. Unlike the first embodiment, the defocus unit is formed such that the rear surface 123 of the first lens in front of the eye is a complete curved surface, and the distance between the two curved surfaces 121 and 123 is approximately uniform in the transmission segment. The projector uses a reflective curved surface 132 and a surface 131 multiplexed for reflection and transmission, and folds the optical path to reduce the size of the system. In order to further improve the image quality, a lens 107 is placed in front of the micro-display image source 104. The lens 107 has two aspherical surfaces 171 and 172.

Image light emitted from the micro-display image source 104 passes through the front and rear surfaces 172 and 171 of the aspherical lens, and is incident on the surface 131 multiplexed for reflection and transmission. After being reflected by surface 131, the light enters the curved reflector 132. After being reflected by surface 132, the light passes through surface 131, and then enters the first lens located in front of the eye through surface 124. The light is reflected and transmitted multiple times between the front and rear surfaces of the first lens until it is incident on the beam splitting exit surface 122 and then is reflected and exits into the human eye.

The position of the micro-display image source 104 can be fixed or dynamically adjusted to form defocused images with different diopter. Preferably, the beam splitter surface 131 uses polarization technology to achieve optical path reversal. Specifically, a polarizing beam splitter film and a quarter-wave plate are laminated on the surface 131. In the light emitted from the micro-display image source 104, s-polarized light is reflected by the polarizing beam splitter film. The reflected light is then converted into circularly polarized light by the quarter-wave plate. After reflection by the curved mirror 132, the circularly polarized light is converted into p-polarized light by the quarter-wave plate. The p-polarized light then passes through the polarizing beam splitter film and enters the first lens. However, this is not a limitation; the planar beam splitter can also be implemented using a non-polarized beam splitting method.

TABLE 2
Parameters of each optical surface in the lens assembly
of the modified embodiment shown in FIG. 8

| Surface | Surface | | X | Y | Z | Alpha |
|---|---|---|---|---|---|---|
| mark | type | Radius | eccentricity | eccentricity | eccentricity | tilt |
| Aperture | Spherical | Infinity | 0 | 0 | 0 | 0 |
| (100) | | | | | | |
| 121 | Aspherical | −192.65 | 0 | 0.000 | 15.00 | 0.00 |
| 122 | XY | −18.34 | 0 | 0.000 | 17.30 | 0.00 |
| | polynomial | | | | | |
| 123 | Aspherical | −168.61 | 0 | 0.000 | 21.00 | 0.000 |
| 124 | Spherical | 32.23 | 0 | 27.45 | 14.77 | 42.56 |
| 131 | Spherical | Infinity | 0 | 27.44 | 20.77 | 75.68 |
| 132 | XY | −9.98 | 0 | 29.40 | 17.55 | 41.65 |
| | polynomial | | | | | |
| 171 | Aspherical | 12.43 | 0 | 31.25 | 13.22 | 114.41 |
| 172 | Aspherical | −5.61 | | 33.24 | 12.31 | 114.41 |
| 104 | Spherical | Infinity | | 34.80 | 11.61 | 83.76 |

Wherein the surface type of surface 121, surface 123, surface 171 and surface 172 is aspherical, and the aspherical can be described by the following equation:

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20}$$

The beam splitting exit surface 122 and the reflective surface 132 are described in the form of XY polynomials, and the equation is as follows:

$$𝓏 = \frac{c ( {x}^{2} + {y}^{2} )}{1 + sqrt ( 1 - ( 1 + k ) {c}^{2} ( {x}^{2} + {y}^{2} ) )} + {\sum }_{{j = 2}^{}}^{66} {C}_{j} {x}^{m} {y}^{m} .$$

### Second Embodiments

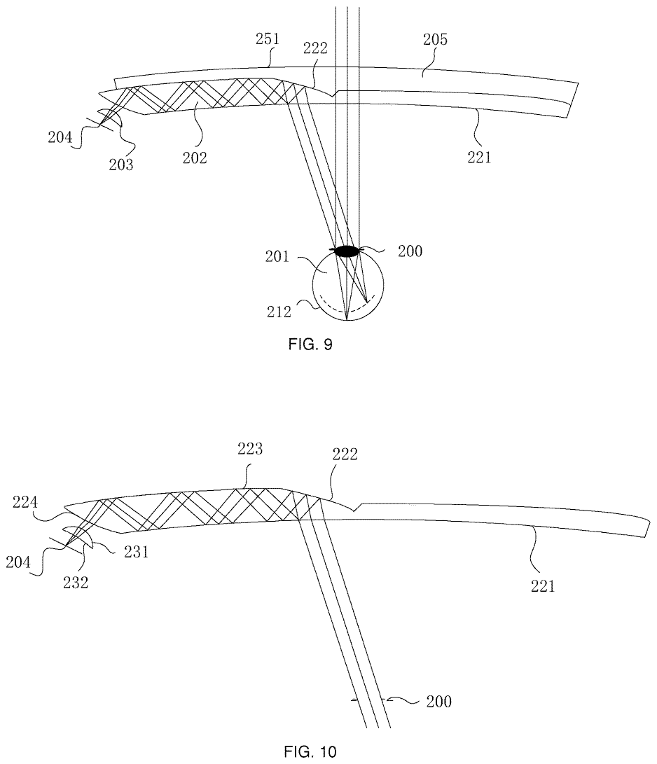

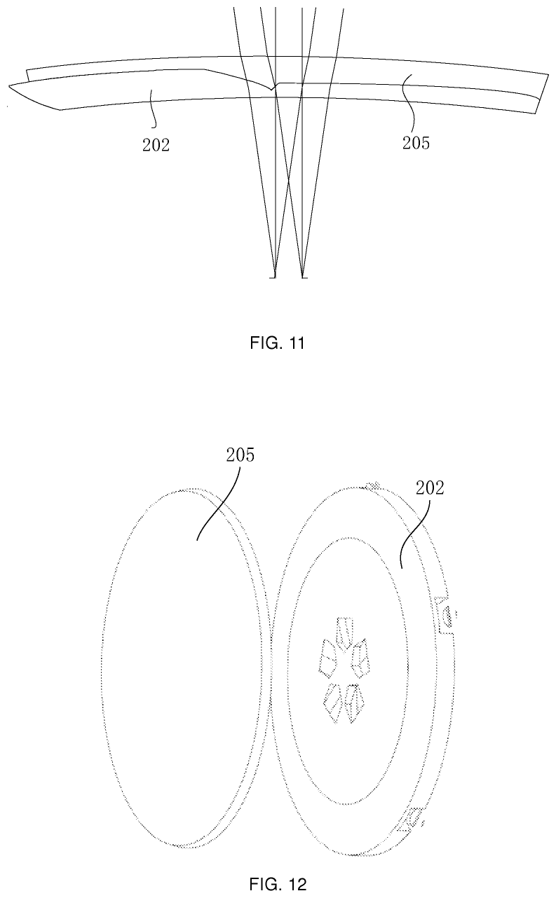

The optical lens assembly for achieving myopic defocus for a user according to the present invention may also comprise a first lens 202 with multiple defocus units as shown in FIG. 9. The first lens is formed in a generally circular or near-circular manner. On the outer side of the first lens 202 (i.e., the side not facing the human eye), there is a second lens 205 that cooperates with the first lens. The defocusing function of the defocus unit is realized by parts of the first lens. The second lens is used to compensate for the surface unevenness of the first lens caused by realizing the defocusing function, and realizes the transmission and vision correction functions similar to normal corrective glasses, as shown in FIG. 11.

### Second Embodiment

As shown in FIG. 10, the defocus unit of the second embodiment comprises: a coupling incident surface 224 disposed on the outer peripheral edge of the first lens, a beam splitting exit surface 222 disposed near the center of the first lens, a reflection transmission surface 223 constituting the outer surface of the first lens, and a reflection transmission surface 221 constituting the inner surface of the first lens. The beam splitting exit surface 222 and the two reflective transmission surfaces are concave (inwardly curved) relative to the eye position in the exit direction. The two reflective transmission surfaces are configured to allow light incident through the coupling incident surface to be transmitted towards the beam splitting exit surface via total internal reflection. The coupling incident surface 224 is inclined from the periphery of the first lens in a manner extending from the second lens towards the eye, and is preferably configured as a spherical surface. The reflective transmission surface 223 is preferably configured as an aspherical surface, which is used to flexibly adjust the degree of bending of the incident light on the front surface 223 of the lens so that the light transmitted through the coupling incident surface into the first lens satisfies the total internal reflection propagation condition. The beam splitting exit surface 222 is preferably configured as a freeform surface, which is used to ensure that the light reaching the beam splitting exit surface no longer has the total internal reflection condition, and is thus guided to exit from the inside of the first lens to the eye to form a myopic defocused image.

Unlike the first embodiment, relative to the human eye position, the coupling incident surface 224 and the beam splitting exit surface 222 are located on the same side of the arc surface of the first lens, so that the total internal reflection of light is transmitted radially along the lens, but does not pass through the center of the lens. During the transmission, the light undergoes at least 6 total internal reflections within the first lens, and there is no intermediate image plane within the first lens during the light transmission process. In the second embodiment, the surface 221 of the first lens facing the human eye is a continuous rotationally symmetric sphere, or optionally an aspherical surface.

In the second embodiment, the projector that projects a predetermined image onto a defocus unit has a lens 203 with a spherical surface, as shown in FIGS. 9 and 10. The image light of the predetermined image passes through the surface 232 of the lens 203 and is incident on the surface 231, and finally exits from the surface 231 to the coupling incident surface 224, enters the first lens.

In this embodiment, the image light enters the first lens through the coupling incident surface 224 and undergoes total internal reflections between the two surfaces 221 and 223. It is then reflected out of the first lens by the beam splitting exit surface 222. The beam splitting exit surface 222 and the coupled incident surface 224 are located on the same side relative to the visual axis, and the light transmission does not cross the center position. Although the light transmission does not cross the center position, it is still preferable to form each defocus unit in a radially distributed manner within the first lens, thereby integrating multiple defocus units in a single lens and forming multiple uniformly distributed defocused images around the field of view. As shown in FIG. 12, five defocus units are radially distributed at equal angles in the first lens. That is, when the first lens is roughly circular, there are no two completely opposite defocus units in the diameter direction of the circle. The beam splitting exit surface 222 has a beam splitting layer with a predetermined transmittance-reflection ratio, such as a semi-reflective film or other beam splitting films with different transmittance-reflection ratios. This allows image light to be reflected back to the interior of the first lens as effectively as possible when it reaches the exit surface. The beam splitting ratio of the beam splitting film can be selected according to the luminance of the micro-display image source 204 and balanced with the intensity of the ambient light to obtain good image contrast.

A tiny air gap exists between the first lens and the second lens to ensure total internal reflection of light within the first lens. The curvature of the second lens's surface 251, furthest from the human eye, can be altered to meet the requirements of users with different diopter regarding the transmission light path. By adjusting the position of the micro-display image source 204 or the lens 203, the defocused image can be dynamically controlled between +1 D and +5 D to correspond to the diopter of the human eye, achieving the purpose of matching the user and vision training.

As shown in FIGS. 9-11, the image light passing through the defocus unit passes through the pupil and the lens of the human eye 201 and is focused in front of the retina 212. Meanwhile, the light emitted from the normal external scene passes directly through the second lens and the first lens into the human eye and is able to focus on the retina 212. This allows the human eye to view the external scene normally while forming a positively defocused image in the periphery of the visual field, providing a certain effect on myopia prevention and treatment.

According to the second embodiment, the aspherical surface type description equation and the freeform surface of the beam splitting exit surface 222, the description is in the form of an XY polynomial, which are consistent with the first embodiment. The optical surface parameters according to the second embodiment can be shown in Table 3 below:

TABLE 3
Parameters of each optical surface in the lens assembly of the second embodiment

| Surface | Surface | | X | Y | Z | Alpha |
|---|---|---|---|---|---|---|
| mark | type | Radius | eccentricity | eccentricity | eccentricity | tilt |
| Aperture | Spherical | Infinity | 0 | 0 | 0 | 0 |
| (200) | | | | | | |
| 221 | Spherical | −183.52 | 0 | 0.00 | 15.00 | 0.00 |
| 222 | XY polynomial | −56.99 | 0 | 5.22 | 17.19 | −14.28 |
| 223 | Aspherical | −320.16 | 0 | 0.00 | 17.70 | 0.00 |
| 224 | Spherical | 16.99 | 0 | 23.97 | 15.23 | −24.87 |
| 231 | Spherical | −1.68 | 0 | 23.32 | 14.13 | −32.69 |
| 232 | Spherical | −6.77 | 0 | 23.75 | 13.46 | −32.69 |
| 204 | Spherical | Infinity | 0 | 24.82 | 12.80 | −25.78 |

### Third Embodiment

Unlike the first embodiment and the second embodiment, the third embodiment of the present invention shows another way of light incident on the first lens. In this embodiment, light enters the first lens through the edge region of the side surface away from the human eye, and after being reflected by the curved surface located on the side and opposited to the beam splitting exit surface, it reaches the side surface away from the human eye. At this time, the light satisfies the condition of total internal reflection. The light is totally internally reflected between the two reflective transmission curved surfaces of the first lens. Finally, it reaches the beam splitting exit surface, and is reflected by the beam splitting exit surface, and exits the first lens, heading towards the human eye. In this embodiment, the shape of the first lens in the defocus unit is similar to that of the first lens in the second embodiment, but the first lens has a region on the side surface away from the human eye that extends beyond the outline of the second lens and is used as the light incident surface 325. The side 324 of the first lens is used as a curved reflective surface. Preferably, a reflective film is coated on the reflective surface to direct the light entering the first lens toward the side surface away from the human eye and to make the reflected light satisfy the total internal reflection condition.

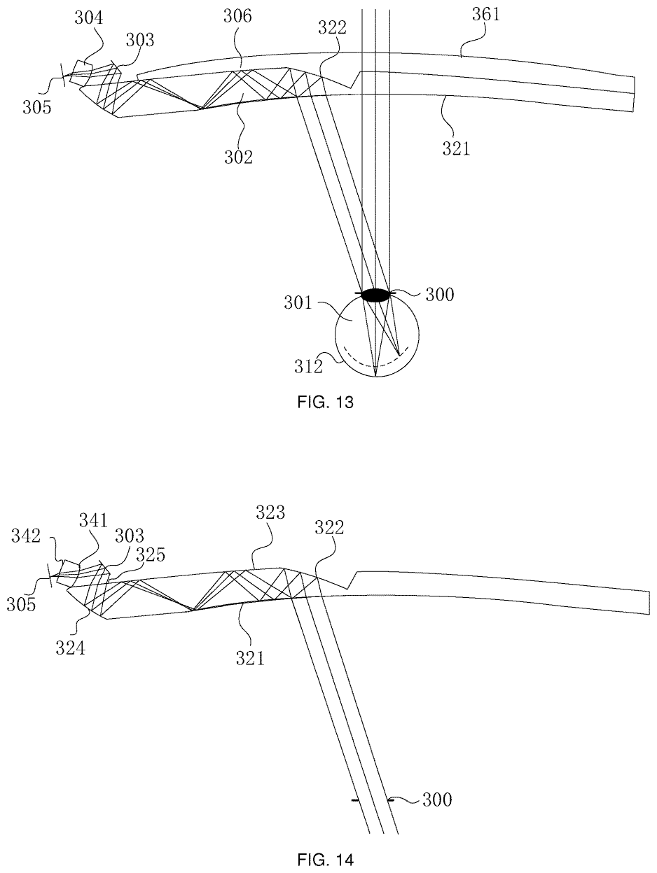

Specifically, as shown in FIGS. 13 and 14, the defocus unit comprises: a coupling incident surface 325 disposed on the outer circumferential edge of the surface of the first lens 302 away from the human eye, a beam splitting exit surface 322 disposed near the center of the first lens, a reflection transmission surface 323 constituting the outer surface of the first lens, a reflection transmission surface 321 constituting the inner surface of the first lens, and a reflection surface 324 constituting the outer periphery of the side surface. The reflection surface 324 is obliquely disposed on the outer circumferential edge of the first lens 302 and serves as a reflecting surface. Surface 324 and surface 321 are not on the same arc surface. Total internal reflection is achieved by coating a reflective film on surface 324. The beam splitting exit surface and the two reflection transmission surfaces are concave surfaces with respect to the human eye position in the exit direction. The two reflection transmission surfaces are positioned so that light incident through the coupling incident surface is transmitted towards the beam splitting exit surface by total internal reflection. The coupling incident surface 325 and the reflection transmission surface 323 on the side away from the human eye are located on the same arc surface and are preferably configured as aspherical surfaces. The reflection surface 324 is preferably configured as a freeform surface to flexibly adjust the degree of bending of the incident light on the lens surface 323 so that the light transmitted through the coupling incident surface into the first lens and reflected by the reflection surface 324 satisfies the total internal reflection propagation condition. The beam splitting exit surface 322 is also preferably configured as a freeform surface to ensure that the light reaching the beam splitting exit surface no longer meets the total internal reflection condition, and is thus reflected and emitted from inside the first lens to the human eye to form a myopic defocused image. Relative to the human eye position, the reflection surface 324 and the coupling exit surface 322 are located on the same arc surface as the human eye position, so that the total internal reflection of light is transmitted radially along the lens, but does not pass through the center point of the lens. Due to the change in the position of the light entering the first lens, the light only needs at least 4 total internal reflections within the first lens during transmission, and an intermediate image plane exists within the first lens during light transmission.

In the third embodiment, the projector that projects a predetermined image onto a defocus unit consists of a lens 304 and a reflector 303. The lens 304 has a spherical surface. The image light of the predetermined image passes through the surface 342 of the lens 304 and is incident on the surface 341, and finally exits from the surface 341 to the reflector 303 and enters the first lens from the side away from the human eye. The reflector 303 is preferably a plane, and its main function is to compress the light path and reduce the size of the projector.

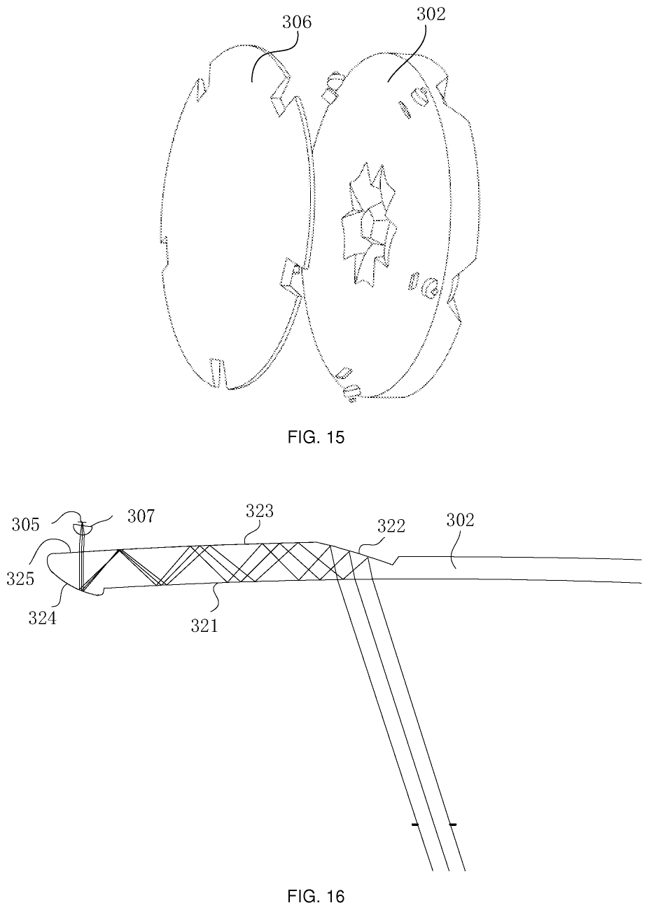

In the third embodiment, each defocus unit is still formed in the first lens in a radially distributed manner, so that a single lens integrates multiple defocus units, forming multiple uniformly distributed defocus images around the field of view, as shown in FIG. 15. However, the change in the projector determines that the second lens have a smaller radius relative to the first lens to accommodate with the projector when adapted, or it has a recessed opening on the circumference relative to the position of each projector.

According to the third embodiment, the aspherical surface description equations and the freeform surface of the beam splitting exit surface 322 are described in the form of XY polynomials, consistent with the first embodiment. The optical surface parameters are shown in Table 4 below:

TABLE 4
Parameters of each optical surface in the optical lens group of the third embodiment

| Surface | Surface | | X | Y | Z | Alpha |
|---|---|---|---|---|---|---|
| mark | type | Radius | eccentricity | eccentricity | eccentricity | tilt |
| Aperture | Spherical | Infinity | 0 | 0 | 0 | 0 |
| (300) | | | | | | |
| 321 | Spherical | −100 | 0 | 0.000 | 15.00 | 0.00 |
| 322 | XY polynomial | −21.92 | 0 | 5.72 | 16.49 | −15.27 |
| 323 | Aspherical | −142.24 | 0 | 0.00 | 17.10 | 0.00 |
| 324 | XY polynomial | 9.23 | 0 | 21.39 | 13.02 | −35.44 |
| 325 | Aspherical | −142.24 | 0 | 0.00 | 17.10 | 0.00 |
| 303 | Spherical | Infinity | 0 | 18.60 | 16.89 | −46.05 |
| 341 | Spherical | −2.57 | 0 | 21.99 | 16.88 | −75.20 |
| 342 | Spherical | 10.71 | 0 | 23.01 | 16.61 | −75.20 |
| 305 | Spherical | Infinity | 0 | 23.48 | 16.49 | −75.20 |

To further optimize the overall shape of the first lens, the projector can also be as shown in FIG. 16, eliminating the plane mirror and consisting only of lens 307. In addition, the curved reflective surface 324 and the beam splitting exit surface 322 adopt freeform surface, and by increasing the radius of the inner and outer surfaces of the first lens, the surface of the first lens is made closer to a plane, and the number of total internal reflections of light in the first lens is increased to 6.

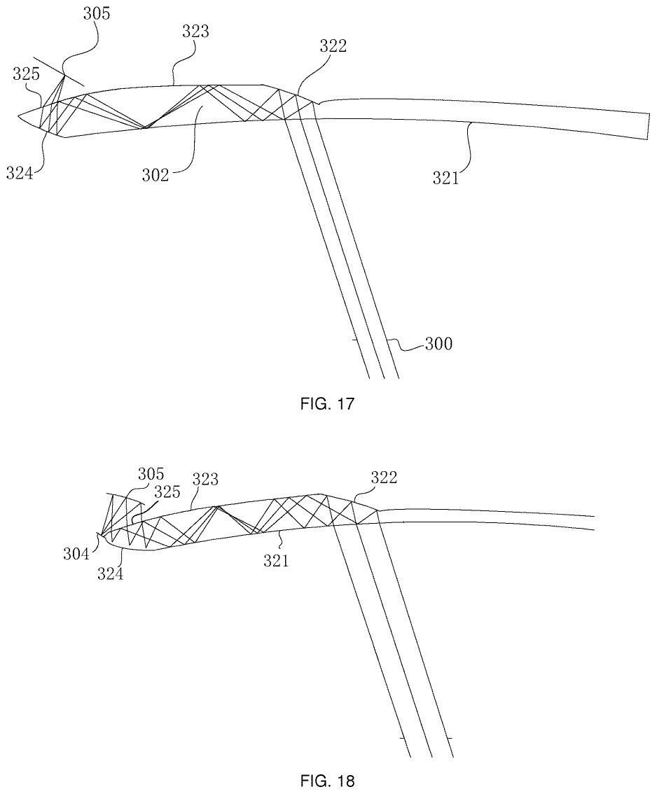

In order to further optimize the shape of the first lens and make the surface of the entire primary mirror smoother, the shape of FIG. 17 is introduced. Among them, the projector only comprises an image source. The light emitted from the image source is directly incident on the light incident surface 325, enters the first lens, and is reflected by the reflective curved surface 324 and then transmitted by total internal reflection between the two curved reflective surfaces. After being reflected by the beam splitting exit surface, it is emitted out of the first lens; when the light is transmitted by total internal reflection between the two curved reflective surfaces, an intermediate image is formed. The light incident surface 325 and the reflective transmission surface 323 form the surface of the first lens 302 away from the human eye. In this embodiment, the reflective transmission surface 321 constituting the inner surface adopts an aspherical surface, and the reflective transmission surface 323, the reflective surface 324, and the beam splitting exit surface 322 constituting the outer surface are all freeform surfaces.

As shown in FIG. 18, the shape of the lens is further optimized so that the reflective surface 324 of the first lens 302 and the reflective transmission surface 321 constituting the inner surface have a smooth transition. The projector comprises only a curved reflector 305. Light emitted from the image source 304 is reflected by the curved reflector 305, then strikes the light incident surface 325, enters the first lens, and undergoes total internal reflection between the two curved reflective surfaces 321 and 323 after reflection by the reflective surface 324. The light then exits the first lens after reflection by the beam splitting exit surface 322. The light undergoes five total internal reflections between the two curved reflective surfaces, forming an intermediate image during the total internal reflection transmission. The light incident surface 325 is the outer region of the reflective transmission surface 323 forming the outer surface. The light incident surface and the reflective transmission surface 323 forming the outer surface of the first lens 302 away from the human eye. The reflective surface 324 forms the side surface of the first lens and transitions arc-shaped with the reflective transmission surface 321 forming the inner surface. In this embodiment, the curved reflector 305 is a spherical or aspherical reflector, the reflective surface 324 and the beam splitting exit surface 322 are freeform surfaces, the surface type of the reflective transmission surface 321 is spherical or aspherical, and the surface type of the reflective transmission surface 323 can be spherical, aspherical, or freeform.

### Fourth Embodiment

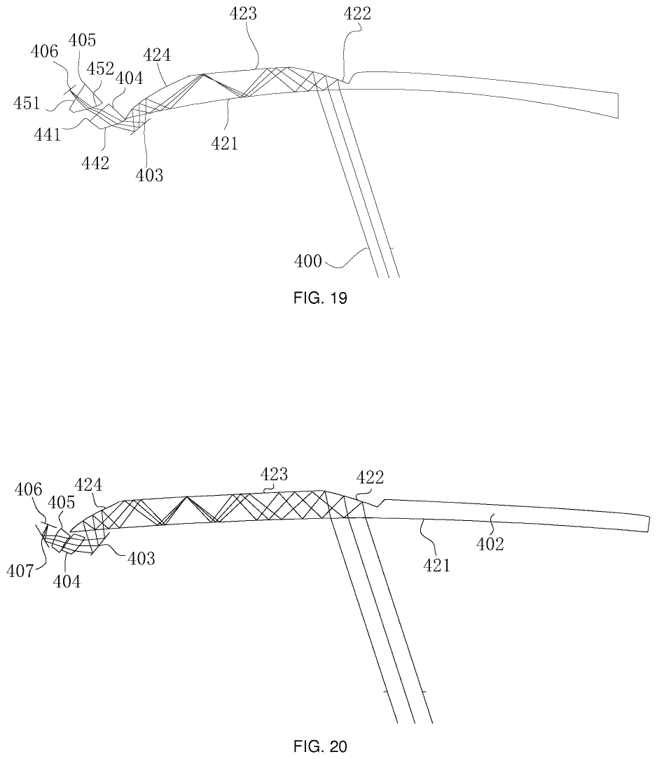

As another embodiment of the present invention without changing the overall concept, according to the fourth embodiment of the present invention, the way that the projector projects incident light onto the first lens is shown in FIG. 19. At this time, the coupling surface of the light is located on the side of the first lens closest to the human eye, in the edge region of the reflective transmission surface 421. The light enters the first lens through this region and is reflected by the reflective surface 424. It is then transmitted by total internal reflection between the two reflective transmission surfaces 421 and 423 until it is reflected out of the first lens by the beam splitting exit surface 422. The light achieves a total internal reflection of 5 times between the two reflective transmission surfaces 421 and 423, and forms an intermediate image plane within the first lens.

In this embodiment, the curved reflective surface 421 of the first lens near the human eye constitutes the inner surface, and the reflective surface 424, the curved reflective surface 423, and the beam splitting exiting surface 422 constitute the surface near the second lens. The reflective surface 424 and the beam splitting exiting surface 422 are both concave towards the human eye. The reflective surface 424 is coated with a total internal reflection film, and the beam splitting exiting surface 422 is coated with a beam splitting film. Furthermore, the reflective surface 424 and the beam splitting exiting surface 422 are freeform surfaces.

In this embodiment, the projector comprises a plane mirror 403 and two lenses 404 and 405; the image light emitted by the micro-display image source 406 passes through the front and rear surfaces 451, 452, 441, and 442 of the two spherical lenses 404 and 405, is incident on the plane 403 and is reflected by the plane 403, and then passes through the surface 521 to enter the first lens. After being reflected by the reflective surface 424, the light is reflected multiple times between the front and rear surfaces of the first lens until it is incident on the beam splitting exit surface 422 and then is reflected and exits into the human eye.

The position of the micro-display image source 406 can be fixed or dynamically adjusted to form defocused images with different diopter.

TABLE 5
Parameters of each optical surface in the
optical lens group of the fourth embodiment

| Surface | Surface | | X | Y | Z | Alpha |
|---|---|---|---|---|---|---|
| mark | type | Radius | eccentricity | eccentricity | eccentricity | tilt |
| Aperture | Spherical | Infinity | 0 | 0 | 0 | 0 |
| (400) | | | | | | |
| 421 | Spherical | −100 | 0 | 0.000 | 15.00 | 0.00 |
| 422 | XY | −22.52 | 0 | 5.58 | 16.58 | −14.93 |
| | polynomial | | | | | |
| 423 | Spherical | −150.51 | 0 | 0.000 | 17.26 | 0.000 |
| 424 | XY | −9.28 | 0 | 21.89 | 13.86 | 36.03 |
| | polynomial | | | | | |
| 403 | Spherical | Infinity | 0 | 18.98 | 14.03 | 40.05 |
| 442 | Spherical | 8.62 | 0 | 21.04 | 14.27 | 51.76 |
| 441 | Spherical | 19.67 | 0 | 23.00 | 15.82 | 51.76 |
| 452 | Spherical | 8.34 | 0 | 23.08 | 15.88 | 51.76 |
| 451 | Spherical | −38.76 | 0 | 25.57 | 17.84 | 51.76 |
| 406 | Spherical | Infinity | 0 | 28.72 | 14.90 | 38.46 |

To further optimize the overall shape of the lens, as shown in the peripheral field defocus optical path diagram in FIG. 20, the radius of the inner and outer surfaces of the lens is increased, making the inner and outer surfaces of the lens closer to a plane, and the number of total internal reflections of light in the lens increases to 8. At the same time, in order to fold the optical path, two plane mirrors and two spherical lenses are used in the projector. Due to this change in the projector, the distance of the projector protruding in the thickness direction of the lens is shortened, which is beneficial to the adaptation of the first lens and the second lens and reduces the overall thickness.

### Fifth Embodiment

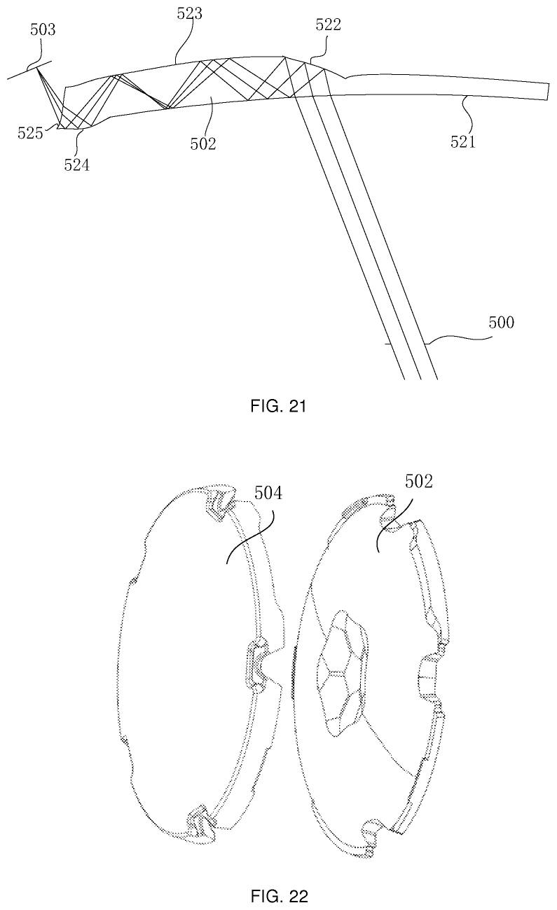

To reduce the difficulty of system assembly and adjustment, the lens group of the projector can be omitted. In the embodiment shown in FIG. 21, in order to achieve a good imaging effect, each surface of the first lens 502 achieves the function of correcting aberrations while meeting the light transmission requirements. The first lens 502 comprises: a light incident surface 525, a reflecting surface 524, two reflective transmission surfaces 521 and 523, and a beam splitting exit surface 522. The light incident surface 525 is located on the side of the first lens and is concave with a freeform surface. After light enters the first lens through the light incident surface 525, it is reflected by the reflecting surface 524 and then strikes the reflective transmission surface 523 forming the outer surface, the light satisfies the condition of total internal reflection in the reflective transmission surface 523. The light then undergoes multiple total internal reflections between the two reflective transmission surfaces 523 and 521, and is reflected by the beam splitting exit surface 522 before exiting the first lens. The light undergoes four total internal reflections within the first lens, and forms an intermediate image within the first lens. In this first lens, the reflecting surface 524 is located on the periphery of the reflective transmission surface 521 that constitutes the inner surface (the surface on the side close to the human eye). The reflecting surface 524 and the reflective transmission surface 521 constitute the surface of the first lens facing the human eye. In this embodiment, the light incident surface 525 is an aspherical surface, the reflecting surface 524 and the beam splitting exit surface 522 are freeform surfaces, the surface type of the reflective transmission surface 521 is spherical or aspherical, and the surface type of the reflective transmission surface 523 can be spherical, aspherical, or freeform. FIG. 22 is a three-dimensional structural schematic diagram of the first lens 502 and the second lens 504.

TABLE 6
Parameters of each optical surface in the optical lens group of the fifth embodiment

| Surface | Surface | | X | Y | Z | Alpha |
|---|---|---|---|---|---|---|
| mark | type | Radius | eccentricity | eccentricity | eccentricity | tilt |
| Aperture | Spherical | Infinity | 0 | 0 | 0 | 0 |
| (500) | | | | | | |
| 521 | Spherical | −105 | 0 | 0 | 15 | 0 |
| 522 | XY | −29.8 | 0 | 5.169 | 16.74 | −17.10 |
| | polynomial | | | | | |
| 521 | Spherical | −105 | 0 | 0 | 15 | 0 |
| 523 | Aspherical | −399109 | 0 | 0 | 17.3 | 0 |
| 521 | Spherical | −105 | 0 | 0 | 15 | 0 |
| 523 | Aspherical | −399109 | 0 | 0 | 17.3 | 0 |
| 524 | XY | 8.038 | 0 | 18.45 | 13.06 | 12.27 |
| | polynomial | | | | | |
| 525 | Aspherical | 5.03 | 0 | 20.13 | 13.88 | 76.33 |
| 503 | Spherical | Infinity | 0 | 22.14 | 16.44 | 22.49 |

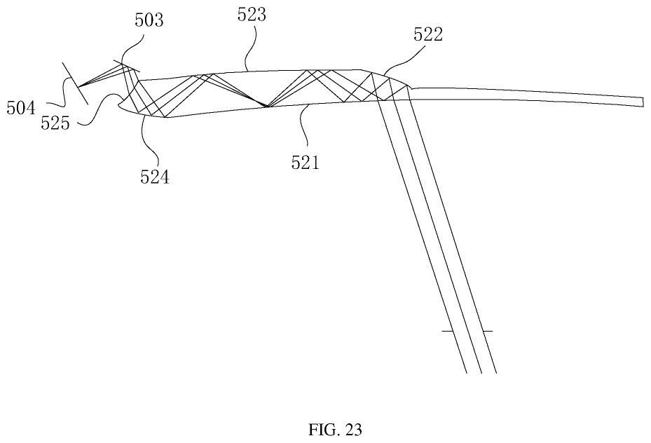

In FIG. 23, in order to reduce the difficulty of system assembly and adjustment, the lens group of the projector can be omitted, and only the reflecting surface is introduced to fold the light path coupled out through the first lens. The projector only comprises a reflector 503, which is used to reflect the light emitted by the micro-display 504 and direct it to the first lens 502. The surface of the reflector 503 can be plane, only serving a folding function, or it can be curved, introducing a certain optical power. By introducing the reflector 503, the volume of the entire projection part is reduced.

### Sixth Embodiment

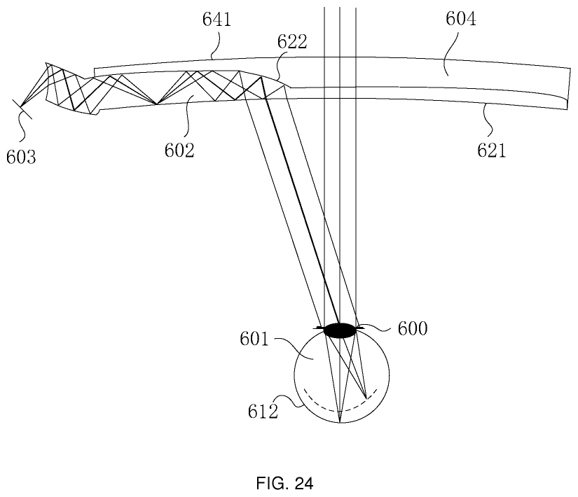

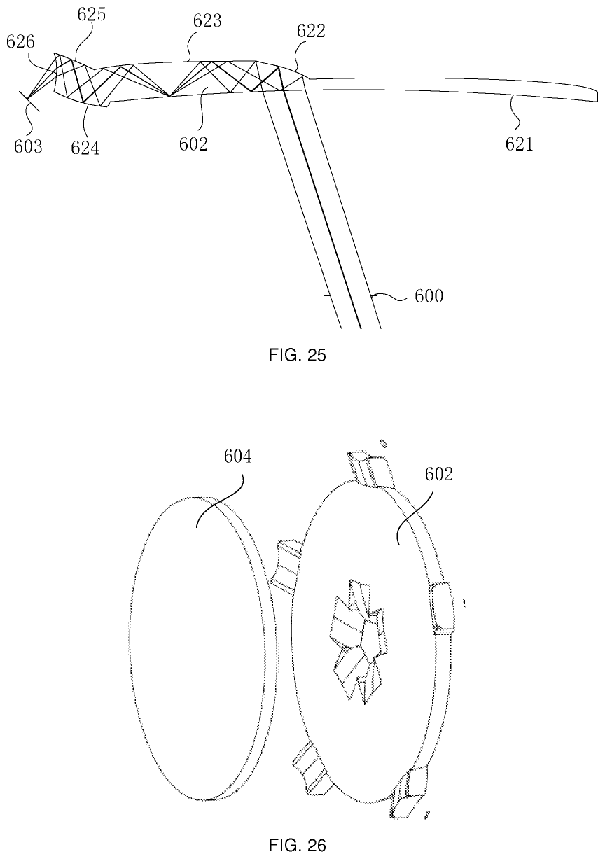

Compared with the previous embodiments, in this embodiment, the projector comprising multiple reflective surfaces can also be formed as a solid and integrally formed with the first lens. As shown in FIGS. 24 and 25, the predetermined image is generated using a micro-display image source 603. In this defocus unit, a projector independent of the first lens 602 is no longer needed. The first lens 602 comprises surfaces 624, 625, and 626 that protrude from its main body and act as projectors. Surface 626 is recessed and directly receives light from the micro-display image source 603 to propagate light to surfaces 625 and 624 under the condition of total internal reflection. The light reflected by surfaces 625 and 624 enters the space between two reflective transmission surfaces 623 and 621, thereby guiding the light into the main body of the first lens. The light entering the main body of the first lens still satisfies the condition of total internal reflection and propagates to the beam splitting exit surface 622 via surfaces 621 and 623 of the first lens. The beam splitting exit surface 622 is preferably set as a freeform surface to ensure that the light propagating to the beam splitting exit surface no longer has the condition of total internal reflection, and is thus reflected and emitted from the inside of the first lens to the exit pupil 600 to form a myopic defocus image. The beam splitting exit surface 622 and the light-incident surface 626 are located on the same side relative to the human eye. The image light does not pass through the center point of the lens during transmission within the defocus unit, and an intermediate image plane exists within the first lens during transmission. Accordingly, as shown in FIG. 26, the second lens 604 has approximately the same size as the main body of the first lens 602 and is adapted to the first lens. The portion of the defocus unit of the first lens 602 located on the periphery of the two reflective transmission surfaces, corresponding to the projector, has a protrusion extending beyond the main body of both the first lens 602 and the second lens 604. The size of the second lens 604 does not affect the protruding portion that functions as a projector.

### Seventh Embodiment

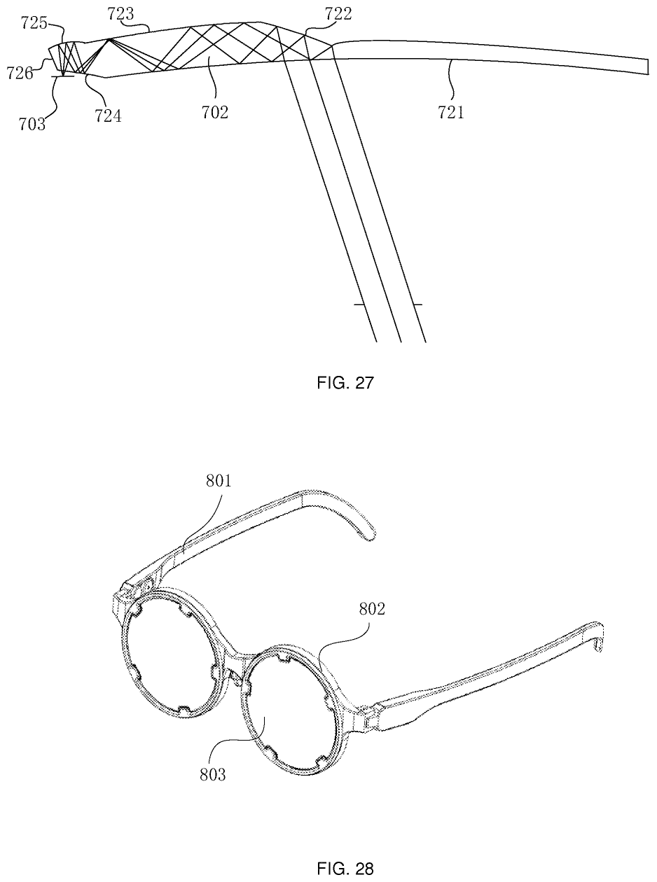

To further optimize the lens shape and make the surface of the first lens smoother, the optical lens assembly shown in FIG. 27 is introduced. The first lens 702, which comprises a projector with multiple reflective surfaces, can also be formed integrally with the first lens as a solid component.

As shown in FIG. 27, this defocus unit no longer requires a projector independent of the first lens 702. The first lens 702 comprises surfaces 724 and 725 that protrude from its main body and function as a projector. Surfaces 724 and 725 are connected by side surface 726. The front surface of the first lens 702 is a splicing surface, composed of two aspherical surfaces, including a reflective and transmissive multiplexed surface 724 and a reflective transmission surface 721. The reflective and transmissive multiplexed surface 724 is located on the periphery of the reflective transmission surface 721 that constitutes the inner surface. The reflective surface 725 and the curved reflective surface 723 constituting the rear surface of the first lens 702. The reflective surface 725 is located on the periphery of the curved reflective surface 723 and coated with a reflective film. The side surface 726 of the first lens 702 is not used as an optical surface.

In this embodiment, the predetermined image is generated using a micro-display image source 703, which is positioned facing surface 724. Light emitted from the micro-display image source 703 passes through surface 724, and after being reflected by surfaces 725 and 724, it enters the space between two reflective transmission surfaces 723 and 721, thereby guiding the light into the main body of the first lens. The light reflected by reflective surface 725 satisfies the total internal reflection condition when it reaches surface 724. The light entering the main body of the first lens still satisfies the total internal reflection propagation condition and propagates through surfaces 721 and 723 of the first lens towards the beam splitting exit surface 722. The beam splitting exit surface 722 is preferably configured as a freeform surface to ensure that the light reaching the beam splitting exit surface no longer satisfies the total internal reflection condition, and is thus reflected and emitted from the first lens to the exit pupil 700 to form a myopic defocus image.

FIG. 28 shows a schematic diagram of the eyeglasses formed by the peripheral myopic defocus system according to the present invention. It comprises rearwardly extending temples 801, a frame 802 located at the front end of the temples, and at least one of the aforementioned optical lens assemblies 803 fixed within the frame. The predetermined image is formed by illuminating a mask image plate with an LED illumination source, or by emitting an image from a micro-display source selected from LCOS, DLP, OLED, or Micro LED. The temples are positioned such that the distance between the side of the first lens facing the human eye and the anterior surface of the eye is in the range of 14 mm to 16 mm, consistent with ordinary corrective eyeglasses. When using an LED light source as the image source, energy consumption is low, luminous intensity is high, and battery requirements are lower. The battery can be placed in the temple, and its shape is basically the same as ordinary eyeglasses, meeting the needs of long-term wear.

According to the optical lens groups of the present invention, the radial distribution of the defocus units needs to ensure that the exit pupil of each defocus unit is the same or is located in the same area. The defocusing range of each beam splitting exiting surface is placed in an obliquely opposite direction relative to the position of the human eye, that is, the defocusing range of the beam splitting exiting surface and the physical position of the beam splitting exiting surface are on opposite sides of the central axis of the lens. The angle θ of the peripheral field of the defocusing effect deviating from the central field (as shown in FIG. 2) is between 15° and 30°. For example, the defocused image at a position about 20° above the central axis of the human eyeball is emitted from the beam splitting exiting surface on the lower side of the lens. In the middle of the lens, the light from the micro-display image source remains propagating in the lens and does not escape to the human eye, thus not affecting the transmission of ambient light directly in front of the human eye's pupil, and better maintaining the defocusing effect.

The first lens, located in front of the eye, is similar to a regular corrective lens, with a diameter of approximately 40-55 mm. The second lens is roughly the same size as the first lens to fit it. This design facilitates the cutting of corrective lenses during the assembly process, allowing for adaptation to different frame shapes. The second lens and/or the first lens are integrally formed using high-precision injection molding of optical resin material, with a total thickness of the two lenses less than 5 mm. Ambient light passes sequentially through the second lens and the first lens before entering the eye. The light transmittance of the second lens is adjustable.

The foregoing detailed description of the present technology is for illustrative and descriptive purposes only. It is not intended to be an exhaustive explanation or to limit the present technology to the precise forms disclosed. In view of the above teachings, many modifications and variations are possible. The described embodiments are merely for the best illustration of the principles of the present technology and its practical application, thereby enabling others skilled in the art to best utilize the present technology in various embodiments, and various modifications suitable for a particular purpose are also possible. The scope of the present technology is defined by the appended claims.

What is claimed is:

1. An optical lens assembly for a user to achieve peripheral myopic defocus, comprising:
a first lens having a plurality of defocus units, the first lens being generally circular and facing the human eye;
a second lens cooperating with the first lens, the second lens having an area roughly the same as that of the first lens and being positioned on the side of the first lens away from the human eye; and
a projector for projecting a predetermined image to a defocus unit, the projector comprising at least one projection optical lens;
wherein image light of the predetermined image enters a defocus unit through the projector, and is reflected at least four times within the first lens to propagate toward the center of the first lens, and then reflected by a beam splitting exit surface opposite the projector to exit the defocus unit and enters the human eye to form a defocused image;
a defocusing range of the beam splitting exit surface is opposite to the physical position of the beam splitting exit surface relative to a central axis of the first lens;
the plurality of defocus units are radially distributed in the first lens.

2. The optical lens assembly as claimed in claim 1, wherein the defocus unit comprises: a coupling incident surface disposed on a outer peripheral edge of the first lens, the beam splitting exit surface disposed near the center of the first lens, and two reflective transmission surfaces constituting the outer surface of the first lens, wherein the beam splitting exit surface and the two reflective transmission surfaces are concave surfaces with respect to the human eye position, and the two reflective transmission surfaces are configured to reflect light incident through the coupling incident surface toward the beam splitting exit surface by total internal reflection.

3. The optical lens assembly as claimed in claim 2, wherein an eye-side surface of the first lens is a rotationally symmetric spherical or aspherical surface, and is in a continuous state.

4. The optical lens assembly as claimed in claim 3, wherein a surface of the first lens located on a side away from the eye is a continuous single surface or a combination of discontinuous surfaces, and light is transmitted between the two surfaces by total internal reflection, or by beam splitting, or by polarization beam splitting.

5. The optical lens assembly as claimed in claim 1, wherein the beam splitting exit surface is a freeform surface.

6. The optical lens assembly as claimed in claim 1, wherein the radially distribution of defocus units are configured to ensure that all exit pupils of the defocus units are the same or located within the same region.

7. The optical lens assembly as claimed in claim 6, wherein the plurality of defocus units are distributed at equal angles, and a number of the defocus units is an odd number greater than or equal to 3 and not exceeding 9.

8. The optical lens assembly as claimed in claim 6, wherein the plurality of peripheral defocus units are distributed at non-equal angles, and a number of the defocus units is greater than or equal to 3.

9. The optical lens assembly as claimed in claim 1, wherein any defocus unit does not form an angle of 180° with other defocus units.

10. The optical lens assembly as claimed in claim 1, wherein an intermediate image plane exists within the first lens for the defocus unit.

11. The optical lens assembly as claimed in claim 1, wherein the projection optical lens of the projector is selected from one or a combination of: a wedge-shaped curved prism, an aspherical lens, and a reflecting mirror.

12. The optical lens assembly as claimed in claim 1, wherein the projection optical lens is a wedge-shaped curved prism, the curved prism comprising a reflective surface and a curved surface multiplexed for reflection and transmission, the surface type of the reflective surface and the curved surface multiplexed for reflection and transmission being selected from one or a combination of: a spherical surface, an aspherical surface, and a freeform surface.

13. The optical lens assembly as claimed in claim 12, wherein the curved surface multiplexed for reflection and transmission achieves multiplexing of reflection and transmission by utilizing total internal reflection, or by utilizing polarization beam splitting based on different polarization states.

14. The optical lens assembly as claimed in claim 11, wherein the projection optical lens comprises at least one lens and at least one reflector, the at least one lens being a spherical or aspherical lens, and the at least one reflector having an aperture stop function to prevent some stray light from entering the projector.

15. The optical lens assembly as claimed in claim 14, wherein the at least one reflector is a plane reflector, the plane reflector achieving reflection by coating a total reflection film or by employing polarization beam splitting based on different polarization states.

16. The optical lens assembly as claimed in claim 1, wherein a curvature of a surface of the second lens away from the eye are adjustable to form a different transmission powers with the surface of the first lens facing the eye, and a light transmittance of the second lens is adjustable.

17. The optical lens assembly as claimed in claim 1, wherein there is a small air gap between the second lens and the first lens, or they are bonded together with an adhesive of a different medium.

18. The optical lens assembly as claimed in claim 1, wherein an angle by which the defocusing range of the beam splitting exit surface deviates from the central field is between 15° and 30°.

19. A pair of glasses for achieving peripheral myopic defocus, comprising: rearwardly extending temples, a frame disposed at the front end of the temples, and at least one optical lens assembly as claimed in claim 1 fixed within the frame, wherein the predetermined image is formed by illuminating a mask image plate with an LED illumination source, or is emitted by a micro-display image source selected from LCOS, DLP, OLED, and Micro LED, and the temples are configured such that the distance between the surface of the first lens on the side facing the human eye and the anterior surface of the eye is in the range of 14 mm to 16 mm.

20. The pair of glasses for achieving peripheral myopic defocus as claimed in claim 19, wherein the position of the micro-display image source is adjustable so that the diopter of the defocused image can be adjusted between +1 D and +5 D.
